(19) United States
(12) Patent Application Publication
(10) Pub. No.: US 2010/0155475 A1
(43) Pub. Date: Jun. 24, 2010

(54) METHOD OF AUTHENTICATING RFID TAG FOR REDUCING LOAD OF SERVER AND RFID READER USING THE SAME

(75) Inventors: Kwangjin PAEK, Seoul (KR); Yuseung Ma, Daejeon-city (KR); Pyeongsoo Mah, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/603,702

(22) Filed: Oct. 22, 2009

(30) Foreign Application Priority Data
Dec. 22, 2008 (KR) 10-2008-0131569

(51) Int. Cl. G06K 7/00

(52) U.S. Cl. 235/439

(57) ABSTRACT

As a method of authenticating an RFID tag in order to reduce a load of a server and improve security, an RFID reader connects an RFID DB server through a network and communicate with a plurality of tags, requests tag information to the tag, and receives an identifier of an array having an index, an index of the array having the index, and an encrypted tag ID from the tag. The array having the index is created by using a master key corresponding to the identifier of the array having the index, which is received from the RFID DB server, an encryption key is created by extracting an array value corresponding to the index, and an tag ID is acquired by decrypting the encrypted tag ID by using the created encryption key.

### RELATED APPLICATIONS

The present application claims priority to Korean Patent Application Serial Number 10-2008-0131569, filed on Dec. 22, 2008, the entirety of which is hereby incorporated by reference.

### BACKGROUND OF THE INVENTION

1. Field of the Invention

The present invention relates to a method of authenticating an RFID tag and an RFID reader using the same, and more particularly, to a method of authenticating an RFID tag for reducing a load of a server and improving security and an RFID reader using the same.

2. Description of the Related Art

In general, radio frequency identification (RFID), as a technology of processing information on an object by using a small-sized semiconductor chip, is a non-contact type identification system that transmits and processes the information on the object and information on a circumferential environment with a wireless frequency by attaching small-sized chips to various articles. This system appeared from 1980s is also referred to as a dedicated short range communication (DSRC) or a radio identification system.

The system including an RFID reader having reading and decryption functions, an RFID tag having unique information, application software, a network, an RFID DB server storing information on the RFID tag, etc. processes the information by identifying a thin flat tag attached onto an object. Since the RFID technology does not need direct contact or scanning in a visible band like a bar code, the RFID technology is assessed as a technology that will substitute for the bar code. A research of the RFID technology is conducted in various fields. The RFID technology is spread and used throughout the world and the standard suitable for the RFID technology is actively prepared.

With development of the RFID technology, the RFID chip is gradually minimized and a communication distance is extended. As the chip is minimized, a coin-sized RFID reader and a point-sized RFID tag are developed and as the communication distance is extended, any one can read the tag information whenever and wherever and a camouflaged tag is prepared, which becomes a problem. Therefore, individuals or businesses which use the RFID system regard information security as their major task.

Further, the RFID DB server storing the information on the tag transmits meta information of the tag to an RFID reader on a request of the RFID reader. As the RFID technology is actively used, the number of tags is increased and a transmission amount between the RFID reader and the RFID DB server is remarkably increased. In this case, as a load of the RFID DB server is increased, a bottleneck phenomenon occurs and problems such as a delay of a response time or a communication error may occur.

FIG. 1 is a configuration diagram schematically illustrating a known RFID system. The RFID system generally includes an RFID DB server 20, an RFID reader 10, and a plurality of tags 30. The RFID reader 10 transmits and receives signals to and from the tag 30 through RF communication and communicates with the RFID DB server through a network in order to acquire the tag information. The tag 30 is generally attached to an object and in the figure, n tags 30-1, 30-2, . . . , 30-n are assumed. Each of the tags 30-1, 30-2, . . . , 30-n has its own tag ID for identifying the object and the RFID reader 10 aims at acquiring the tag ID of each tag through an authentication process. When the tag ID is exposed, a problem occurs. Therefore, the RFID reader 10 can acquire the tag ID by communicating with the RFID DB server 20 storing the tag information through the network.

The RFID reader 10 communicates with the RFID DB server 20 whenever identifying each of the plurality of tags 30 and acquires information on the corresponding tag. As the number of tags increases, the load of the RFID DB server 20 is rapidly increased. Further, in order to improve the security, etc., a communication amount of the RFID system is increased and as a result, the load of the RFID DB server 20 is also increased. When the load of the RFID server is increased, the problem such as the delay of the response time or the communication error occurs and technological development of the RFID system is impeded.

In addition, in general, security connection having improved security is established in the communication between the RFID reader 10 and the RFID DB server 20. On the contrary, since RF connection adopting a radio frequency is adopted in communication between the RFID reader 10 and the tag 30, the communication between the RFID reader 10 and the tag 30 can be easily exposed to have weak security. Tags used for a distribution system communicate with different RFID reader 10 through a distribution channel several times. In this case, information exposed during the several-time communication processes may be tracked back. Therefore, a core task of the RFID technology field is to solve a security problem of data that are transmitted and received between the RFID reader and the tag.

### SUMMARY OF THE INVENTION

The present invention is contrived to solve the above-mentioned problems. An object of the present invention is to provide a method of authenticating an RFID tag for reducing a load of a server by decreasing the number of times of requesting information to an RFID DB server for acquiring tag information on a plurality of tags and dynamically creating an encryption key and an RFID reader.

Another object of the present invention is to provide a method of authenticating an RFID tag for acquiring efficiency while dynamically creating an encryption key and increasing complexity of the encryption key and improving security by periodically updating the encryption key and an RFID reader.

In order to achieve the above-mentioned objects, according to an embodiment of the present invention, a method of authenticating an RFID tag, which is performed in an RFID reader that is connected with an RFID DB server through a network and communicates with a plurality of tags includes: a tag information requesting step of requesting tag information to a tag; a tag information receiving step of receiving an identifier of an array having an index, an index of the array having the index, and an encrypted tag ID from the tag; an array creating step of creating the array having the index by using a master key corresponding to the identifier of the array having the index, which is received from the RFID DB server; an encryption key creating step of creating the encryption key by extracting an array value corresponding to the index in the array having the index created at the array creating step; and a tag ID acquiring step of acquiring the encrypted tag ID received at the tag information receiving step by using the encryption key created at the encryption key creating step.

Further, it is preferable that the array having the index is an S-box and it is preferable that a random value is transmitted to the tag at the tag information requesting step. In addition, at the tag information receiving step, it is preferable that a random value is further received. Further, it is preferable that the identifier of the array having the index is the same with respect to a plurality of tags that belong to the same tag group. Further, the method of authenticating an RFID tag further includes, when the master key corresponding to the identifier of the array having the index, which is received at the tag information receiving step is not provided, transmitting the identifier of the array having the index to the RFID DB server and receiving the master key corresponding to the identifier.

It is preferable that at the tag information receiving step, a counter value is further received. It is preferable that the method of authenticating an RFID tag further includes: a counter value comparing step of comparing a counter threshold value with the received counter value; and a counter value increasing step of transmitting the increased counter value to the tag when the received counter value received from the comparison result at the counter value comparing step is not larger than the counter threshold value.

It is preferable that the method of authenticating an RFID tag further includes, when the received counter value is larger than the counter threshold value from the comparison result at the counter value comparing step, a new master key receiving step of receiving the identifier of the array having the index from the RFID DB server and a new master key corresponding to the identifier. It is preferable that the method of authenticating an RFID tag further includes: a new encryption key creating step of creating a new encryption key by using the master key received at the new master key receiving step, transmitting the identifier of the array having the index and the tag ID encrypted by the new encryption key, and a verification response receiving step of receiving a verification response for verifying the identifier of the array having the index from the tag. In addition, the method of authenticating an RFID tag further includes a counter initialization value transmitting step of transmitting a counter initialization value to the tag.

According to another embodiment of the present invention, an RFID reader includes: a network communication unit that is connected with an RFID DB server through a network; an RF communication unit that receives an identifier of an array having an index, an index of the array having the index, and an encrypted tag ID from a tag; an array creation unit that creates the array having the index by using a master key corresponding to the received identifier of the array having the index; an encryption key creation unit that creates an encryption key by extracting an array value corresponding to the received index from the array having the index, which is created by the array creation unit; and a control unit that acquires a tag ID by decrypting the received encrypted tag ID by using the encryption key created by the encryption key creation unit.

It is preferable that the array having the index is an S-box. It is preferable that when the master key corresponding to the identifier of the array having the index, which is received by the RF communication unit is not provided, the identifier of the array having the index is transmitted to the RFID DB server and the master key corresponding to the identifier is received, the RF communication unit further receives a counter value from the tag, and when the received counter value is larger than a counter threshold value from a result of comparing the counter threshold value with the received counter value, the identifier of the array having the index and a new master key corresponding to the identifier are received from the RFID DB server through the network communication unit.

Further, it is preferable that a new encryption key is created by the array creation unit and the encryption key creation unit by using the received new master key and the identifier of the array having the index and the tag ID encrypted by the new encryption key are transmitted to the tag through the RF communication unit.

According to an embodiment of the present invention, it is possible to reduce a load of a server by decreasing the number of times of requesting information to an RFID DB server for acquiring tag information on a plurality of tags. The same S-box identifier is granted to a tag group that is constituted by a plurality of tags and when an S-box identifier received from the tag is an already received S-box identifier, a process of receiving a master key by inquiring of the RFID DB server can be omitted, thereby reducing a transmission load of the RFID DB server. When the same S-box identifier is granted to a plurality of tags positioned in a predetermined area, an advantage of the present invention will be further shown. Although the same S-box identifier is granted to the plurality of tags, an encryption key can be dynamically created by differentiating an S-box index of each tag, such that a value of the encryption key for decrypting a tag ID is changed, thereby improving security and increasing availability.

Further, according to the embodiment of the present invention, it is possible to improve the security by periodically updating the encryption key. The number of times of authenticating the tag or the number of times of transmitting a message is recorded in a counter value and when the counter value is larger than a counter threshold value, the encryption key is updated, and new S-box information and a new encryption key are transmitted to and stored in the tag. Accordingly, it is possible to prevent the risk of security caused by information exposure due to accumulated communications between an RFID reader and the tag, which has not established security. Further, since an already stored S-box identifier and a master key corresponding to the S-box identifier can be used without always connecting an RFID server even while updating the encryption key, it is possible to reduce the load of the RFDI server while updating the encryption key.

### BRIEF DESCRIPTION OF THE DRAWINGS

FIG. 1 is a configuration diagram schematically illustrating a known RFID system;

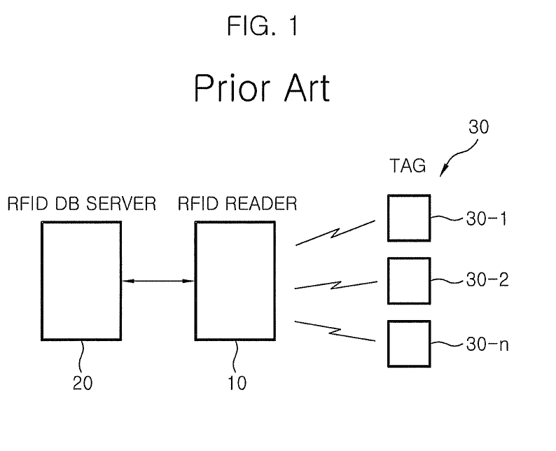

FIG. 2 is a block diagram illustrating an RFID system according to an embodiment of the present invention;

FIG. 3 is a block diagram of a configuration of a tag according to an embodiment of the present invention;

FIG. 4 is a block diagram for describing an S-box creation unit and an encryption key creation unit according to an embodiment of the present invention;

FIG. 5 is a flowchart illustrating steps of authenticating an RFID tag according to an embodiment of the present invention; and

FIG. 6 is a flowchart illustrating steps of updating an encryption key according to an embodiment of the present invention.

### DETAILED DESCRIPTION OF THE PREFERRED EMBODIMENTS

Hereinafter, preferred embodiments of the present invention will be described with reference to the accompanying drawings in order to help understand the present invention. The embodiments to be described are provided to more easily understand the present invention. The present invention is not limited to the embodiments.

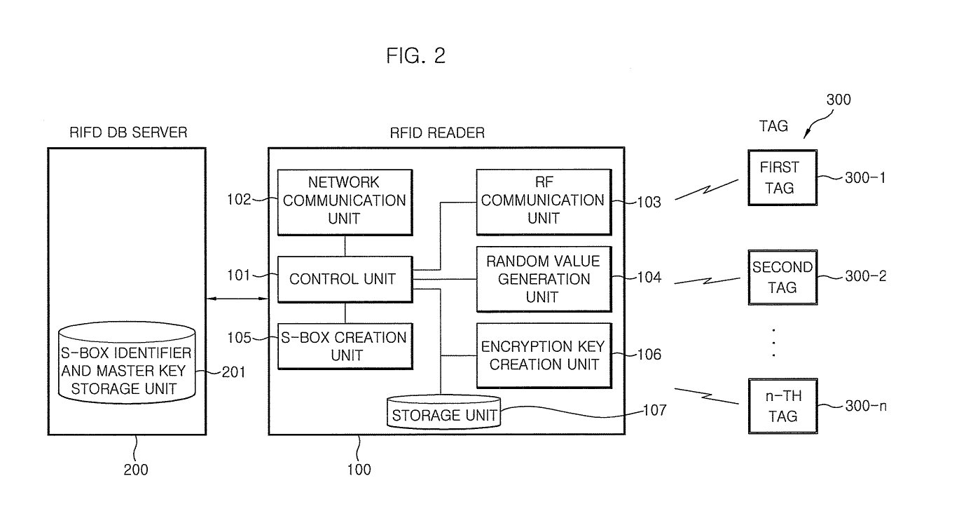

FIG. 2 is a block diagram illustrating an RFID system according to an embodiment of the present invention. The RFID system includes an RFID DB server 200, an RFID reader 100, and a plurality of tags 300. Besides, other components may be connected and other components in each component are provided, but only components required for describing the present invention are illustrated and the present invention will be described by using the illustrated components below. Various known components is applicable without departing from the spirit of the present invention.

The RFID DB server 200 stores tag information on the plurality of tags 300. The RFID DB server 200 manages the tag information of the corresponding tag and is provided with various components for transmitting the tag information to the RFID reader, but only an S-box identifier and master key storage unit 201 which are components required for describing the present invention are illustrated.

Herein, the substitution box (S-box) is a technology which is variously used particularly in a symmetric key encryption technology and creates an array having an index value by hashing by means of a master key. The S-box will be described in more detail below and omitted description will be easily understood by those skilled in the art on the basis of description of the present invention. An array which is created by an algorithm that creates an array value by means of the master key other than the S-box can be used in the present invention. This array is generally referred to as ‘array having an index’.

Hereinafter, an example of the array having the index will be described by using the S-box.

The RFID DB server 200 stores an S-box identifier. The S-box identifier is a virtual identifier and a master key for creating the corresponding S-box corresponds to each S-box identifier and is stored in the S-box identifier and master key storage unit 201. Accordingly, when the S-box identifier is inquired of the RFID DB server 200, the corresponding master key can be acquired and the S-box can be created by using the acquired master key.

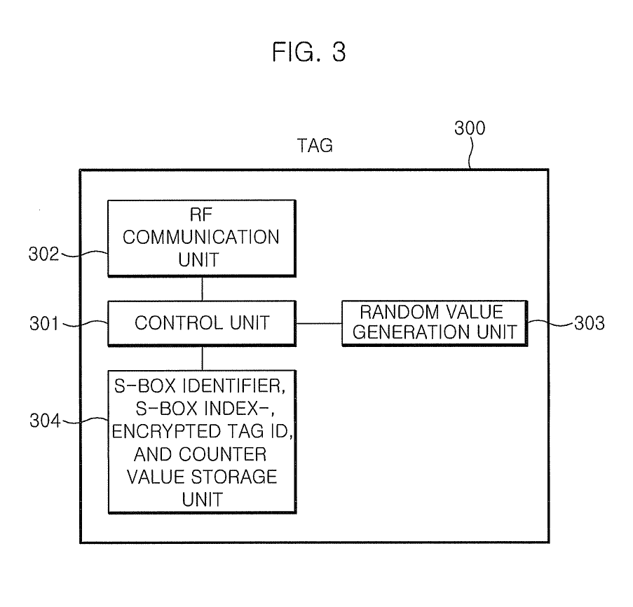

The plurality of tags 300 may be arranged in the same space and information relating to the tags 300 is stored in the RFID DB server 200 at the time of manufacturing the tags. In FIG. 2, n tags 300-1, 300-2, . . . , 300-n are assumed. Each of the tags 30-1, 30-2, . . . , 30-n has its own tag ID for identifying an object. The tags will be described below with reference to FIG. 3.

FIG. 3 is a block diagram illustrating a configuration of a tag according to an embodiment of the present invention. The tag 300 includes a control unit 301, an RF communication unit 302, a random value generation unit 303, an S-box identifier, S-box index, encrypted tag ID, and counter value storage unit 304 as a storage unit.

The control unit 301 is a calculation and control device that can control components of the tag 300 and perform calculation. The RF communication unit 302 is a communication component that can transmit and receive necessary data by performing RF communication with the RFID reader 100 of FIG. 2. In addition, the random value generation unit 303 generates a random value r to be annexed to a message transmitted to the RFID reader from the RF communication unit 302 and receives and decodes an encrypted message to analyze the message by the transmitted random value.

Next, the storage unit 304 stores an S-box identifier, an S-box index, an encrypted tag ID, and a counter value. The S-box identifier is an identifier for identifying all arrays having an index as stored in the RFID DB server 200 and the RFID reader serves as an identifier for acquiring the master key for creating the S-box. The S-box identified is expressed by ids. The S-box index indicates a position in the S-box array and is used to extract a necessary value in the created S-box. For example, when the S-box is constituted by z arrays, the S-box index has two values and when the two values are a and b, S-box[a] and S-box[b] are extracted. The S-box index value may be one or more and hereinafter, it is assumed that the S-box index value is two.

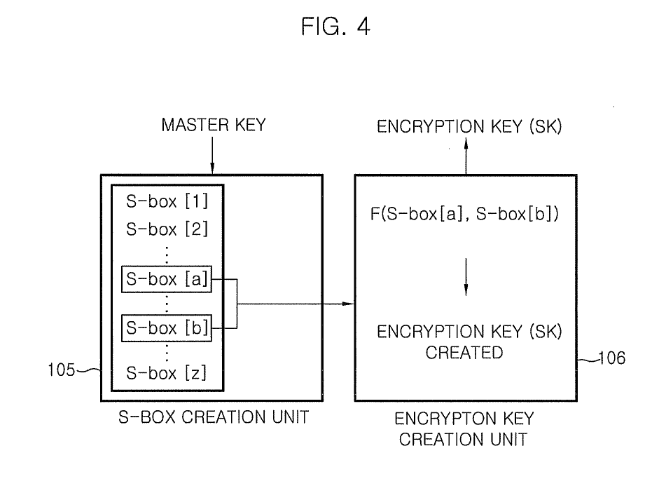

The encrypted tag ID E_{SK}(id_{T}) is a value encrypting a tag ID id_{T} using the encryption key SK. The tag ID id_{T} as a unique value of each tag is a value granted at the time of manufacturing the tag. Each tag is discriminated by the tag ID in the RFID reader. When the tag ID is encrypted and stored at the time of manufacturing the tag and when the encryption key is changed according to the present invention, the stored value is changed into a value encrypting the tag ID by using a new encryption key. Herein, the encryption key SK for encrypting the tag ID id_{T} is a value generated after creating the S-box by using the master key and will be described in detail below with reference to FIG. 4.

The above-mentioned S-box identifier, S-box index, and encrypted tag ID are created and stored at the time of manufacturing the tag and values of the S-box identifier, the S-box index, and the encrypted tag ID can be updated in order to improve the security according to the present invention.

In addition, a counter value c is stored in the storage unit 304 of the tag 300. When the counter value c as, for example, a value that increases depending on the number of times of authentication is larger than a counter threshold value, the counter value c is initialized with updating the S-box identifier, the S-box index, and the encrypted tag ID. The counter value increases depending on the number of times of authentication and when the counter value is equal to or larger than a predetermined value, the counter value is a reference value for updating the S-box identifier, the S-box index, and the encrypted tag ID in order to improve the security. The tag itself may increase the counter value for every authentication or receive the increased counter value from the RFID reader and store the received counter value. It is preferable that the tag more preferably receives the increased counter value from the RFID reader and stores the received counter value in order to perform minimum calculation.

Referring back to FIG. 2, the RFID reader 100 will be described. The RFID reader 100 includes various components for transmitting and receiving, and processing necessary data by communicating with the tag 300 and transmitting and receiving, and processing necessary data by communicating with the RFID DB server 200, but components required for describing the present invention are illustrated and described.

The RFID reader 100 includes a control unit 101, a network communication unit 102, an RF communication unit 103, a random value generation unit 104, an S-box creation unit 105, an encrypted key creation unit 106, and a storage unit 107. The control unit 101 is a calculation and control device such as a CPU that can control components of the RFID reader 100 and perform calculation. The network communication unit 102 is a communication component that can transmit and receive necessary data by performing network communication with the RFID DB server 200. The RFID reader 100 and the RFID DB server 200 are generally subjected to security connection. The RF communication unit 103 is a communication component that can transmit and receive necessary data by performing RF communication with the tag 300. In addition, the random value generation unit 304 generates a random value r to be annexed to a message transmitted to the tag from the RF communication unit 103. The random value generation unit 304 receives a message encrypted by the transmitted random value from the tag 300 and decodes the encrypted message by using the stored random value to analyze the message. The storage unit 107 stores various values and arrays created from the RFID reader 100 and uses the stored values or arrays later.

Next, the S-box creation unit 105 and the encryption key creation unit 106 for creating the encryption key by using the master key according to the embodiment of the present invention will be described. Operations of the S-box creation unit 105 and the encryption key creation unit 106 will be described in detail with reference to FIG. 4.

FIG. 4 is a block diagram for describing an S-box creation unit and an encryption key creation unit according to an embodiment of the present invention. The S-box creation unit 105 receives the master key MK for creating the S-box. The RFID reader transmits the S-box identifier idₛ received from the corresponding tag to the RFID DB server 200, and receives a master key corresponding to the S-box identifier idₛ from the RFID DB server 200 and stores the master key.

The S-box creation unit 105 creates an S-box array having an index value by using the master key MK, for example, by hashing. For example, when the number of the S-box arrays is z, arrays of S-box[1], S-box[2], s-box[z] are created by the hashing. The S-box arrays are determined depending on a value of the master key MK. Since the S-box identifier idₛ corresponds to the master key MK, the S-box arrays are determined depending on the S-box identifier idₛ. That is, in the present invention, when the S-box identifiers idₛ are the same as each other, the same S-box arrays are created.

A formula creating the S-box arrays is, for example, S-box[n]=F(MK_{Ti}, n). Herein, S-box[n] is a value of the S-box when the S-box index is n (n is an integer between 1 and z and MK_{Ti} is a master key acquired with respect to a predetermined tag Ti. Further, the function F, as a message authentication code (MAC) pseudo-random function, is S-box[n]=F(MK_{Ti}, n)=MAC(MK_{Ti}, n).

As such, when the S-box arrays are created by using the master key MK in the S-box creation unit 105, an S-box value corresponding to the S-box index acquired with respect to the corresponding tag is extracted. For example, when the acquired S-box indexes are a and b, array values of S-box[a] and S-box[b] are extracted from the created S-box arrays and transmitted to the encryption key creation unit 106. When the S-box indexes are different from each other even with respect to the plurality of tags having the same S-box identifier, different S-box values can be extracted from the same S-box array and the resultant created encryption key SK is also different.

The encryption key creation unit 106 creates the encryption key SK by using the received S-box values S-box[a] and S-box[b]. For example, the encryption key SK can be created through a formula of F(S-box[a], S-box[b]) by using the same function as creating the S-box arrays. The encryption key creation unit 106 transmits and stores the encryption key SK created with respect to the corresponding tag to and in the control unit 301. Therefore, the encryption key SK for an authentication work with the corresponding tag is acquired. The encryption key is used for encrypting or decrypting the tag ID id_{T}.

According to the embodiment of the present invention, the RFID reader acquires the master key corresponding to the S-box identifier idₛ received from the tag from the RFID DB server and creates the S-box arrays by using the master key. That is, in the tag group constituted by the plurality of tags, when the S-box identifiers idₛ is the same, the S-box can be created by using the master key MK already received by the RFID reader. As a result, since the process of receiving the master key MK from the RFID DB server can be omitted, it is possible to reduce the load of the RFID DB server. Furthermore, when the S-box is created and stored by using the already received master key MK, the S-box creation process can be omitted while authenticating the plurality of tags having the same S-box identifier idₛ.

Meanwhile, even in the plurality of tags having the same S-box identifier idₛ, when the S-box indexes are different, different encryption keys SK are created. That is, since the encryption keys SK are created with S-box values extracted by different indexes in the created S-box array, an authentication work can be performed by using different encryption keys SK even though the S-box identifiers idₛ of the tags are the same, thereby improving the security.

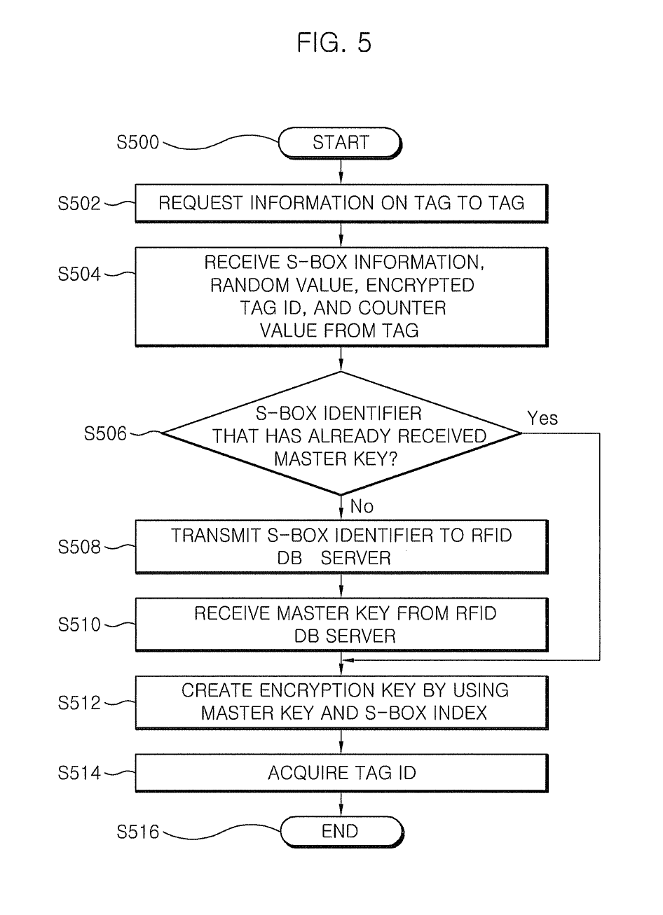

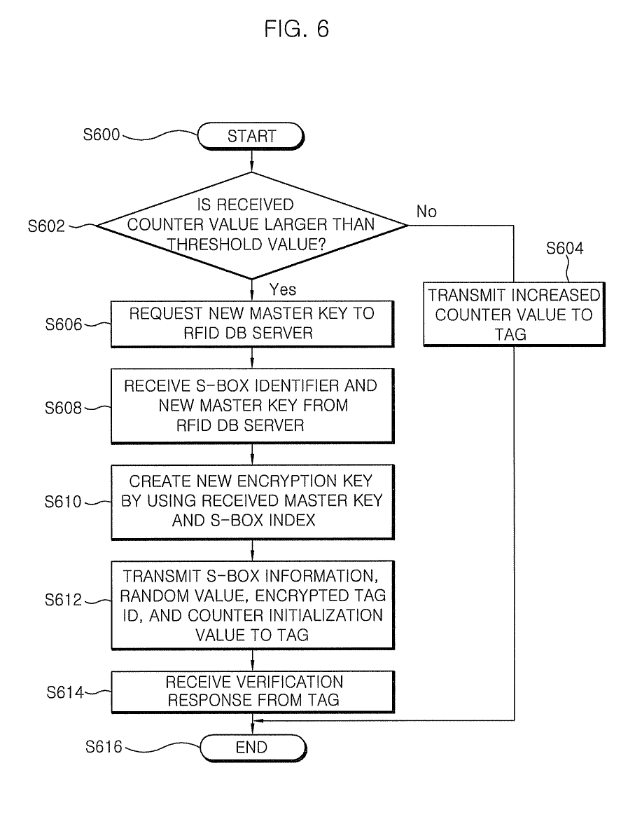

A method of authenticating an RFID tag according to an embodiment of the present invention will be described by using flowcharts of FIGS. 5 and 6. The method of authenticating an RFID tag will be described with reference the configurations of the block diagrams in FIGS. 2 to 4.

FIG. 5 is a flowchart illustrating steps of authenticating an RFID tag according to an embodiment of the present invention. At step S500, authenticating the RFID tag starts. It is assumed that a communication channel is established between the RFID reader 100 and the tag 300 before authenticating the RFID tag starts.

Next, at step S502, the RFID reader 100 requests the tag information to the tag 300. The RFID reader transmits a random value r1 generated by the random generation unit 104 at the time of requesting the tag information. The random value r1 is a key value for encrypting a message which the tag will transmit to the RFID reader afterwards.

Different key values may be used without using the random value r1 in order to encrypt the message and transmission of the random value may be omitted. Even in the following description, it is the same as above.

At step S504, the tag encrypts S-box information idₛ₁, a1, and b1, a random value r2, an encrypted tag ID E_{SK1}(id_{T}), and the counter value c by using r1 as the key and transmits them to the RFID reader and the RFID reader receives them. That is, Eᵣ₁(idₛ₁∥a1∥b1∥r2∥E_{LK1}(id_{T})∥c) is transmitted to the RFID reader from the tag.

Herein, the S-box information includes the S-box identifier idₛ₁ and the S-box indexes a1 and b1. The RFID reader can create an encryption key SK₁ by using the received S-box information. The random value r2 is a key value for encrypting a message which the tag will transmit to the RFID reader afterwards. In addition, the tag ID E_{SK1}(id_{T}) as a value encrypted by using the encryption key SK₁ can be decrypted only by acquiring the encryption key SK₁. The counter value c is a value representing the number of times of authentication stored in the stage unit of the tag. Other values such as the number of times of transmitting the message in addition to the number of times of authentication can be used as the counter c. The counter value c is used at updating the encryption key to be described by using FIG. 6.

Next, at step S506, it is determined whether or not the master key is received with respect to the received S-box identifier idₛ₁. That is, it is determined whether or not the master key is received by inquiring of the RFID DB server by already receiving the same S-box identifier as the received S-box identifier. If the master key MK₁ is already received with respect to the received S-box identifier idₛ₁, steps S508 to S510 are omitted and the process proceeds to step S512. That is, inquiring of the RFID DB server is omitted by omitting receiving the master key MK₁ by transmitting the S-box identifier idₛ₁ to the RFID DB server, thereby reducing the load of the RFID DB server. If the S-box identifier is not the already received S-box identifier from the determination result at step S506, that is, a new S-box identifier without the corresponding master key, the process proceeds to step S508.

At step S508, the S-box identifier idₛ₁ received from the corresponding tag is transmitted to the RFID DB server.

The RFID DB server extracts the S-box identifier and the master key MK₁ corresponding to the S-box identifier received from the master key storage unit 201 and transmits the extracted S-box identifier and master key MK₁ to the RFID reader, and the RFID reader receives the master key MK₁, at step S510.

Next, the process proceeds to step S512 and at step S512, the encryption key SK₁ is created by using the master key MK₁, received from the RFID DB server and the S-box indexes a1 and b1 received from the tag. More specifically, the S-box array is created in the S-box creation unit 105 by using the master key MK₁ received earlier. If it is determined that the S-box identifier is the S-box identifier that already receives the master key at step S506 and steps S508 to S510 are omitted, creating the S-box is omitted. At this time, it is assumed that the S-box for the corresponding master key MK₁ is stored in the storage unit 107. In spite of the already received master key MK₁, if the S-box relating to the corresponding master key MK₁ is not stored, the S-box array is created in the S-box creation unit 105.

In addition, S-box[a1] and S-box[b1] are extracted from the S-box array by using the S-box indexes a1 and b1 received from the tag and transmitted to the encryption key creation unit 106 in the S-box creation unit 105, and the encryption key creation unit 106 creates the encryption key SK1 by using the received S-box[a1] and S-box[b1].

Next, at step S514, the tag ID idT of the corresponding tag is acquired. The tag ID id_{T} of the corresponding tag is acquired by decrypting the encrypted tag ID E_{SK1}(id_{T}) received from the tag at step S504 by using the created encryption key SK1. In addition, at step S516, authenticating the tag ID is terminated.

According to the present invention, when the S-box identifier received from the tag is the already received S-box identifier, receiving the master key MK₁ by inquiring of the RFID DB server can be omitted, thereby reducing a transmission load of the RFID DB server. When the same S-box identifier is granted to a plurality of tags positioned in a predetermined area, an advantage of the present invention will be further shown. Although the same S-box identifier is granted to a plurality of tags that belong to the same tag group as the plurality of tags, an encryption key can be dynamically created by differentiating an S-box index of each tag, such that a value of the encryption key for decrypting a tag ID is changed, thereby improving security and increasing availability. As such, when the tag ID is acquired by authenticating the RFID tag, the RFID reader updates the encryption key as shown in FIG. 6.

FIG. 6 is a flowchart illustrating steps of updating an encryption key according to an embodiment of the present invention. At step S600, updating the encryption key starts and the process proceeds to step S602. At step S602, it is determined whether or not the received counter value c is larger than a predetermined counter threshold value cₜₕ. The counter threshold value cₜₕ may be differently set depending on a usage status or a location. For example, when the tag is used in an area having secured security, the counter threshold value cₜₕ can be set to 1000 and when the tag is used in an area having weak security, the counter threshold value cₜₕ can be set to 10. Radio frequency communication is performed between the tag and the RFID reader. Therefore, when the same pattern is continuously observed even though the encrypted message is transmitted and received, a content of the message can be analyzed by a method such as tracking. As a result, in the present invention, the encryption key SK can be periodically updated by setting the counter threshold value cₜₕ and comparing the set counter threshold value cₜₕ with the counter value c.

From the determination result at step S602, when it is determined that the received counter value c is not larger than the counter threshold value cₜₕ (No of step S602), step S604 is performed and the process is terminated. At step S604, the received counter value c is increased and the increased counter value is transmitted to the tag. For example, Eᵣ₂(c+1∥r3) is transmitted. With the increased counter value c+1, a random value r3 which is a value for encrypting a message which the tag will transmit to the RFID reader afterwards is encrypted and transmitted by using the random value r2 from the tag. The tag stores the received increased counter value c+1 in the storage unit 304 and is used at the step of authenticating the tag or the step of transmitting the message. Meanwhile, step S604 may be omitted. That is, the tag can calculate and update the increased counter value c+1 by directly increasing the counter value after transmitting the counter value c to the RFID reader. In this case, step S604 of transmitting the increased counter value from the RFID reader to the tag is omitted. However, step S604 is preferably performed in order to reduce a calculation burden of the tag.

Meanwhile, from the determination result at step S602, when it is determined that the receive counter value c is larger than the counter threshold value cₜₕ (YES at step S602), it is determined that the number of times at which data transmitted to and received from the tag and the process proceeds to step S606 and the encryption key SK is updated, thereby improving the security of the RFID system. For reference, the encryption key of the corresponding tag which is being currently grasped in the RFID reader is SK₁.

At step S606, the RFID reader transmits a request signal for requesting a new master key to the RFID DB server. The RFID DB server that receives the request signal selects an S-box identifier idₛ₂ and extracts a new master key MK₂ corresponding to the selected S-box identifier idₛ₂ from the S-box identifier and master key storage unit 201 from the S-box identifier and master key storage unit 201. In addition, the RFID DB server transmits the selected S-box identifier idₛ₂ and the extracted new master key MK₂ to the RFID reader and at step S608, the RFID reader receives the S-box identifier idₛ₂ and master key MK₂. Herein, it is preferable that the S-box identifier which the RFID DB server selects and transmits to the RFID reader is a new S-box identifier that is not allocated to the existing other tag from a security aspect. Meanwhile, it is preferable that the same S-box identifier is used with respect to tags that belong to the same area or the same item group. In this case, steps S606 to S608 are omitted and the encryption key can be updated by using the already stored S-box identifier and the master key corresponding to the S-box identifier with respect to the tags that belong to the same area or the item group. Whether or not the tags are the tags that belong to the same area or the same item group, that is, the tags that belong to the same tag group can be verified by whether or not the S-box identifier of the tag is the same before updating the encryption key. Using the already stored S-box identifier and the master key corresponding to the S-box identifier is applicable even though the tags do not belong to the same area or the same item group.

Next, at step S610, a new encryption key SK2 is created by using the received master key MK₂ or the stored master key and S-box indexes a2 and b2 as described by using FIG. 4. Herein, in the case of the used S-box indexes a2 and b2, the S-box indexes a1 and b1 stored in the corresponding tag may be used as it is, but it is further preferable that the index value is change and used in order to improve the security.

Next, the process proceeds to step S612 and S-box information, a random value, an encrypted tag ID, and a counter initialization value are transmitted to the tag. More specifically, the RFID reader encrypts the new S-box information idS2, a2, and b2, a random value r3 which is a key value for encrypting the message transmitted by the tag, the tag ID E_{SK2}(idT) which is encrypted by a new encryption key, and the counter initialization value c0 by using r2 as a key and transmits them to the tag. That is, Eᵣ₂(idₛ₂∥a2∥b2∥r3∥E_{SK2}(id_{T})|c₀) is transmitted to the RFID reader from the tag.

At step S612, the tag that receives the S-box information, the encrypted tag ID, and the counter initialization value updates the corresponding values and the encryption key is updated. The updated S-box information, the encrypted tag ID, and the counter initialization value are used at a follow-up authentication step with another RFID reader.

Next, at step S614, the RFID reader receives a verification response for verifying whether or not the tag accurately receives the S-box information transmitted at step S612. The verification response message may include at least one of the S-box information, the random value, the encrypted tag ID, and the counter initialization value. The risk of exposure can be prevented by transmitting a value hashing the at least one and in addition, the hashed value may be encrypted by using the received random value r3. For example, the verification response message is Eᵣ₃(F(idₛ₂, a2∥b2∥r3)). When it is verified that the tag accurately receives the corresponding information by inspecting the verification response, updating the encryption key is terminated at step S616.

According to the present invention, the number of times of authenticating the tag or the number of times of transmitting the message is recorded in the counter value c and when the counter value is larger than the counter threshold value cₜₕ, the new S-box information and the new encryption key are transmitted to and stored in the tag after updating the encryption key SK. Accordingly, it is possible to prevent the risk of security caused by information exposure due to accumulated communications between an RFID reader and the tag, which has not established security. Further, since an already stored S-box identifier and a master key corresponding to the S-box identifier can be used without always connecting an RFID server even while updating the encryption key, it is possible to reduce the load of the RFDI server while updating the encryption key.

A load of an RFID DB server of an RFID system can be reduced and in addition, security can be improved by a method of authenticating an RFID tag and an RFID reader according to the present invention, thereby largely contributing to realize a useful RFID system.

1. A method of authenticating a Radio Frequency Identification (RFID) tag, which is performed in an RFID reader that is connected with an RFID DB server through a network and communicates with a plurality of tags, comprising:
requesting tag information to a tag;
receiving an identifier of an array having an index, an index of the array having the index, and an encrypted tag identification (ID) from the tag;
creating the array having the index by using a master key corresponding to the identifier of the array having the index, which is received from the RFID DB server;
creating the encryption key by extracting an array value corresponding to the index in the array having the index created at the array creating operation; and
acquiring the tag ID by decrypting the encrypted tag ID received at the tag information receiving operation by using the encryption key created at the encryption key creating operation.

2. The method of authenticating an RFID tag according to claim 1, wherein the array having the index is a substitution box (S-box).

3. The method of authenticating an RFID tag according to claim 1, wherein at the tag information requesting operation, a random value is transmitted to the tag.

4. The method of authenticating an RFID tag according to claim 1, wherein at the tag information receiving operation, a random value is further received.

5. The method of authenticating an RFID tag according to claim 1, wherein the identifier of the array having the index is the same with respect to a plurality of tags that belong to the same tag group.

6. The method of authenticating an RFID tag according to claim 1, further comprising:
when the master key corresponding to the identifier of the array having the index, which is received at the tag information receiving operation is not provided, transmitting the identifier of the array having the index to the RFID DB server and receiving the master key corresponding to the identifier.

7. The method of authenticating an RFID tag according to claim 1, wherein at the tag information receiving operation, a counter value is further received.

8. The method of authenticating an RFID tag according to claim 7, further comprising:
comparing a counter threshold value with the received counter value; and
transmitting the increased counter value to the tag when the received counter value received from the comparison result at the counter value comparing operation is not larger than the counter threshold value.

9. The method of authenticating an RFID tag according to claim 7, further comprising:
comparing a counter threshold value with the received counter value; and
when the received counter value is larger than the counter threshold value from the comparison result at the counter value comparing operation, a new master key receiving step of receiving the identifier of the array having the index from the RFID DB server and a new master key corresponding to the identifier.

10. The method of authenticating an RFID tag according to claim 9, further comprising:
creating a new encryption key by using the master key received at the new master key receiving operation.

11. The method of authenticating an RFID tag according to claim 10, further comprising:
transmitting the identifier of the array having the index and the tag ID encrypted by the new encryption key to the tag.

12. The method of authenticating an RFID tag according to claim 11, further comprising:
receiving a verification response for verifying the identifier of the array having the index from the tag.

13. The method of authenticating an RFID tag according to claim 9, further comprising:
transmitting a counter initialization value to the tag.

14. An RFID reader, comprising:
a network communication unit that is connected with an RFID DB server through a network;
an RF communication unit that receives an identifier of an array having an index, an index of the array having the index, and an encrypted tag ID from a tag;
an array creation unit that creates the array having the index by using a master key corresponding to the received identifier of the array having the index;
an encryption key creation unit that creates an encryption key by extracting an array value corresponding to the received index from the array having the index, which is created by the array creation unit; and
a control unit that acquires a tag ID by decrypting the received encrypted tag ID by using the encryption key created by the encryption key creation unit.

15. The RFID reader according to claim 14, where the array having the index is a substitution box (S-box).

16. The RFID reader according to claim 14, wherein when the master key corresponding to the identifier of the array having the index, which is received by the RF communication unit is not provided, the identifier of the array having the index is transmitted to the RFID DB server through the network communication unit and the master key corresponding to the identifier is received.

17. The RFID reader according to claim 14, wherein the RF communication unit further receives a counter value from the tag.

18. The RFID reader according to claim 17, wherein when the received counter value is larger than a counter threshold value from a result of comparing the counter threshold value with the received counter value, the identifier of the array having the index and a new master key corresponding to the identifier are received from the RFID DB server through the network communication unit.

19. The RFID reader according to claim 18, wherein a new encryption key is created by the array creation unit and the encryption key creation unit by using the received new master key.

20. The RFID reader according to claim 19, wherein the identifier of the array having the index and the tag ID encrypted by the new encryption key are transmitted to the tag through the RF communication unit.
